(19) United States
(12) Patent Application Publication
(10) Pub. No.: US 2002/0165783 A1
(43) Pub. Date: Nov. 7, 2002

(54) Accounting in peer-to-peer data communication networks

(76) Inventors: Jean-Charles Gonthier, Outremont (CA); Eric Richer, Repentigny (CA)

Correspondence Address: ERICSSON RESEARCH CANADA, 8400 DECARIE BLVD., MONTREAL, QC, H4P 2N2, CA

(21) Appl. No.: 09/682,608

(22) Filed: Sep. 26, 2001

Related U.S. Application Data
(60) Provisional application No. 60/287,734, filed on May 2, 2001.

(51) Int. Cl. G06F 17/60

(52) U.S. Cl. 705/26

(57) ABSTRACT

The invention is a method, a system, and network nodes for charging for services in a data communications network having a User, a Service Provider, an Accounting Manager and an Accounting Storage. When a user wants to access a service, it sends a request to the Accounting Manager that validates the request in order to send a service credential to the User and a user credential to the Service Provider. The User then sends a service request to the Service Provider and the requested service is initiated. When the service is terminated, the Service Provider sends an accounting message to the Accounting Manager that sends the accounting data to the Accounting Storage that stores the data, and, upon reception of an acknowledgement, deletes the data it sent to the Accounting Storage. Also described are the system and the network nodes for carrying out the invention.

### CROSS REFERENCE TO RELATED APPLICATIONS

PRIORITY STATEMENT UNDER 35 U.S.C.119(e) & 37 C.F.R.S.1.78. This non-provisional patent application claims priority based upon the prior U.S. provisional patent application entitled “Software Deployment, Accounting and Personal Portal”, application No. 60/287,734 filed May 2, 2001, in the name of GONTHIER Jean-Charles, RICHER Eric, HOST Gerald, JODOIN Pierre-Luc, FOURNIER Nicolas, MALTAIS Robert Claude, VAN BUNNINGEN Thomas, HARNOIS Serge, WALLNER Sabine, BRASK Patrik

### BACKGROUND OF INVENTION

1. Technical Field of the Invention

The present invention relates to data communications networks, and particularly to accounting in such networks.

2. Description of Related Art

Peer-to-Peer networks are networks in which each network element (peer), such as for example a user device or a server, can communicate directly with other network elements. For example, instead of sending mail to a mail server and then have the recipient download it, a peer would send the mail directly to the recipient without intermediary (other than routers and the like).

To the present day, Peer-to-Peer networks have been used in trusted environments, such as for example in a local network where network access is only allowed from a number of known devices. User authentication is unnecessary in such a trusted network, and since there is no user authentication accounting is impossible as there is know way of knowing who used a certain service. This usually is no big problem, since the peers in a trusted environment either do not expect to be paid for the services they provide or are paid by the network administrator that for instance may charge the peers a flat fee.

In an open network environment, i.e. a network that is accessible by “anyone”, service providers usually expect to be paid for the services they provide. In these open networks, the users must be authenticated in order for real accounting for the use of services to be possible. Furthermore, peers that provide a service often have no own means to perform authentication and accounting.

It can therefore be appreciated that there is a need for a solution that overcomes the problems and limitations of the prior art by providing secure charging. This invention provides such a solution.

### SUMMARY OF INVENTION

The present invention is directed to a method for charging in a data communications network comprising a User, a Service Provider that provides at least one service, and an Accounting Manager. The Accounting Manager sends a service credential to the User and a user credential to the Service Provider. The User requests a service from the Service Provider that validates the request. The service is then initiated. After that, the Service Provider sends an accounting message to the Accounting Manager.

The present invention is further directed to a system for charging in a data communications network. The system comprises a User, a Service Provider that provides at least one service, and an Accounting Manager. The Accounting Manager sends a service credential to the User and sends a user credential to the Service Provider. The User requests a service from the Service Provider using information from the service credential, and the Service Provider validates the request and sends an accounting message to the Accounting Manager.

The present invention is further directed to a User node in a data communications network further comprising a Service Provider and an Accounting Manager. The User node comprises a communication unit that receives a service credential from the Accounting Manager and requests a service from the Service Provider.

The present invention is further directed to an Accounting Manager in a data communications network further comprising a User and a Service Provider. The Accounting Manager comprises a communication unit that sends a service credential to the User, sends a user credential to the Service Provider, and receives an accounting message from the Service Provider.

The present invention is further directed to a Service Provider providing at least one service in a data communications network that further comprises a User and an Accounting Manager. The Service Provider comprises a communication unit that receives a user credential from the Accounting Manager, receives a request for a service from the User, and sends an accounting message to the Accounting Manager.

The present invention is further directed to a system for charging in a data communications network that further comprises a User. The system comprises a Service Provider that provides at least one service, and an Accounting Manager. The Accounting Manager is sends a service credential to the User, sends a user credential to the Service Provider, and receives a request for a service from the User. The Service Provider validates the service request, using information from the user credential, and sends an accounting message relating to the service to the Accounting Manager.

### BRIEF DESCRIPTION OF DRAWINGS

A more complete understanding of the present invention may be had by reference to the following Detailed Description when taken in conjunction with the accompanying drawings wherein:

FIG. 1 depicts a block chart of an exemplary network environment in which the invention may be used;

FIG. 2 depicts a signal flow chart of a preferred embodiment of the method according to the invention; and

FIG. 3 depicts a simplified block chart of an exemplary network node.

### DETAILED DESCRIPTION

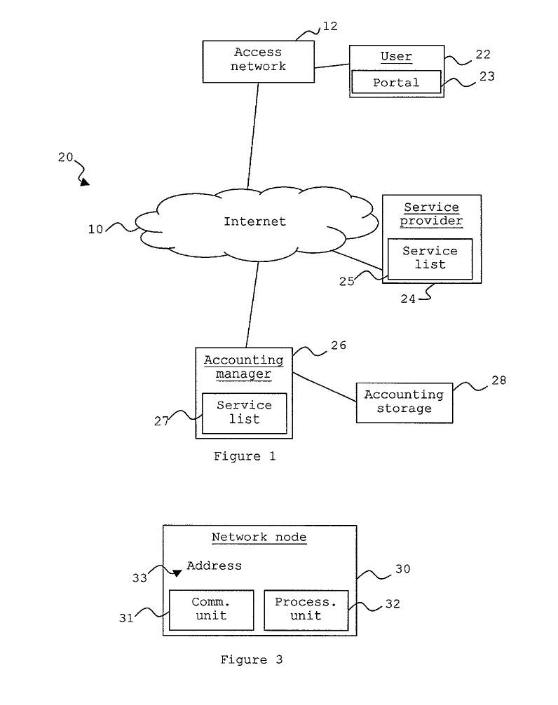

Reference is now made to the Drawings, where FIG. 1 depicts a block chart of an exemplary network environment in which the invention may be used. In the network 20, is shown a User 22 connected to the Internet 10 through an access network 12. The User 22 may be a person using some kind of device to interface with the network or it may be an intelligent device. The User 22 may have an Internet portal 23 (hereinafter called portal) or other interface through which the User 22 can use services and browse for information. It is preferable if the User 22 has logged on to the portal 23 so that the portal 23 may act in the User′″ 22 name directly without having the User 22 authenticate himself for example every time a service is to be used. The portal 23 itself is however beyond the scope of this invention.

There is further a Service Provider 24, with a direct connection to the Internet 10, that is willing to provide services detailed in a first service list 25 to the User 22 for money. The network 20 further comprises an Accounting Manager 26, also with a direct connection to the Internet 10, that among other things is in charge of accounting for at least the services detailed in a second service list 27 that it may provide to the User 22 that may store it as service list 27″, as will be further described hereinafter. There is also an Accounting Storage 28 in which accounting data are stored. The Accounting Storage 28 is connected to the Accounting Manager 26, in this case directly, but they may also be interconnected via the Internet 10 or be co-located.

In an exemplary scenario, the User 22 wishes to use a service provided by the Service Provider 24. The service may for example be a stock analysis or a game and the Service Provider 24 is willing to let the user partake of the service for a fee that for example may depend on the length of the utilisason.

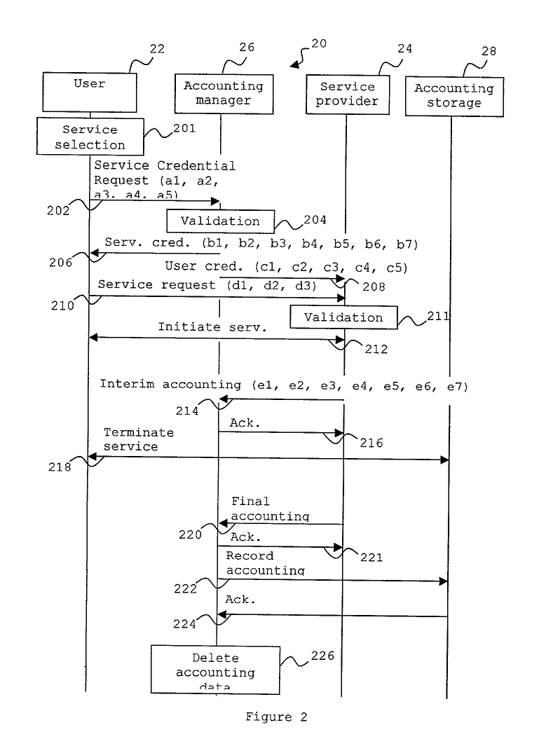

FIG. 2 depicts a signal flow chart of a preferred embodiment of the method according to the invention. This method allows a user to request and use a service provided by a peer, and also allows proper accounting. The figure shows, in a network 20 comprising for example the Internet (10 in FIG. 1), the User 22, the Service Provider 24, the Accounting Manager 26 and the Accounting Storage 28.

It will be assumed that both the User 22 and the Service Provider 24 each have a valid security association, also called a trust relationship, with the Accounting Manager 26.

A security association is one way to authenticate an entity in a network. This may for instance be a shared secret that no one else knows about. When one entity wants to authenticate another entity it asks for their shared secret and if the response comprises the correct secret, then the other entity is authenticated. An example of such a secret is an encryption key. The first entity draws a random number and sends it to the second entity. Both entities encrypt the number using their shared encryption key. The second entity sends the encrypted number to the first entity that then is able to compare the two encrypted numbers. Encrypting random numbers is a way to make sure that a third entity may not learn the shared secret, as the secret is not the number itself nor its encrypted version, but rather the encryption key per se.

Another example is public key encryption (PKE) where an entity has a private key that only the entity itself knows and a public key that may be known to the entire world. A message encrypted with the public key may only be decrypted with the corresponding private key, and vice versa. Hence, a message encrypted with the private key may be said to have been signed by the corresponding entity; an electronic signature so to speak.

This way an entity that only knows the public key of one entity, may ask that entity for the public keys of other entities. Thus, two entities that previously did not know each other's public keys may gain knowledge of this, usually through an entity they both trust.

A person skilled in the art will appreciate that these were merely two examples of security associations and that other variants exist.

It will further be assumed that the Accounting Manager 26 has a list (27 in FIG. 1) of services that it supports, i.e. that it among other things provides accounting for.

The Accounting Manager 26 already has, perhaps during a previous session, provided the User 22 with a list of available services (27″ in FIG. 1).

The User 22 is able to communicate with the Service Provider 24 and the Accounting Manager 26 through an interface, such as for example the portal 23 shown in FIG. 1, or a, possibly mobile, agent (not shown) acting on the User's 22 behalf.

Turning now to the description of the steps of the method according to the invention.

The User 22 selects a service in the list of services, step 201, whereupon a Service Credential Request 202 is sent to the Accounting Manager 26. This Service Credential Request 202 comprises:

An indication of the requested service. (al)

A unique identifier for the Service Credential Request 202. (a2)

A random number to be used for authentication using the security association. (a3)

An electronic signature that authenticates the User 22 to the Accounting Manager 26. (a4)

A Certificate (e.g. according to the X.509 standard). (a5)

Upon reception of the Service Credential Request 202, the Accounting Manager 26 validates the former, step 204, and, if the validation was successful, responds with a Service Credential 206 that 206 comprises:

The unique identifier from the Service Credential Request 202. (b1)

The address of the Service Provider 24. (b2)

A validity period or conditions for the use of the credential. (b6, b7)

An electronic key that will allow the User 22 and the Service Provider 24 to authenticate one another. (b3)

A unique accounting session identifier to be used for accounting for the User 22 for the particular use of the service. (b4)

An electronic signature that authenticates the Accounting Manager 26 to the User 22. (b5)

The Accounting Manager 26 also sends a User Credential 208 to the Service Provider 24. The User Credential 208 comprises:

The address of the User 22. (c1)

The unique accounting session identifier to be used for accounting for the User 22 for the particular use of the service. (c2)

An electronic key that will allow the User 22 and the Service Provider 24 to authenticate one another. (c3)

An electronic signature that authenticates the Accounting Manager 26 to the Service Provider 24. (c4)

Policies (c5) that specify under what conditions the User 22 may access the service, such as for example lifetime, time of day, maximum number of requests, and whether the user is allowed to change his address. In addition, there are accounting policies such as for example the data that is to be collected and the maximum time between accounting messages.

The User 22 then sends a Service Request 210 to request the service from the Service Provider 24. This Service Request 210 comprises:

The address of the User 22. (d1)

The unique accounting session identifier. (d2)

An electronic signature authenticating the User 22. The signature is built using the electronic key provided by the Accounting Manager 26. (d3)

The Service Provider 24 then validates the Service Request 210, step 211, using information from the User Credential. if the Service Request 210 is validated, the service is then initiated 212 by the Service Provider 24, the User 22, or by the Service Provider 24 and the User 22 together, and the service session begins. During the service session the content of any messages sent between the User 22 and the Service Provider 24 are specific to the service and fall outside the scope of the invention. However, these messages may comprise an electronic signature that authenticates them to the receiving entity.

In addition, depending on the configuration of the service and the accounting policies specified by the Accounting Manager 26, the Service Provider 24 may send one or more Interim Accounting messages 214 to the Accounting Manager 26. Each Interim Accounting messages 214 comprises:

A unique identifier of the service. (e1)

An indicator that the message comprises interim accounting data. (e2)

The User Credential identifying the User 22. (e3)

A unique accounting message identifier. (e4)

Accounting data. (e5)

The accounting session identifier. (e6)

An electronic signature identifying the Service Provider 24 to the Accounting Manager 26. (e7)

Upon reception of an Interim Accounting message 214, the Accounting Manager 26 may respond with an Acknowledgement 216.

The User 22 or the Service Provider 24 may terminate the service session, step 218.

Once the service is terminated, the Service Provider 24 sends to the Accounting Manager 26 a Final Accounting message 220 comprising:

A unique identifier of the service.

An indicator that the message comprises final accounting data.

The User Credential identifying the User 22.

A unique accounting message identifier.

Accounting data.

The accounting session identifier.

An electronic signature identifying the Service Provider 24 to the Accounting Manager 26.

The Accounting Manager acknowledges the Final Accounting message 220 with an acknowledgement 221.

Every now and then, depending on pre-established policies agreed upon between the Accounting Manager 26 and the Accounting Storage 28, the former sends its stored accounting data to the latter in a Record Accounting message 222. Upon reception of this message, the Accounting Storage 28 stores the data and sends an Acknowledgement 224 to the Accounting Manager 26 that, upon reception of the Acknowledgement 224, deletes, step 226, the accounting data it sent to the Accounting Storage 28 in the Record Accounting message 222.

FIG. 3 depicts an exemplary network node such as for example an Accounting Manager 26. The network node 30 comprises a communication unit 31 for communication with other nodes in the network and a processing unit 32 for processing data. The network node also has a network address 33.

While the description illustrates a peer-to-peer network, it should be understood that the present invention also could be used in other kinds of networks.

Although several preferred embodiments of the methods, systems and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for charging in a data communications network, the network comprising a User, a Service Provider that provides at least one service, and an Accounting Manager, the method comprising the steps of:
sending by the Accounting Manager a service credential to the User;
sending by the Accounting Manager a user credential to the Service Provider;
requesting by the User a service from the Service Provider, using information from the service credential;
validating by the Service Provider the request for a service, using information from the user credential;
initiating the service; and
sending by the Service Provider an accounting message relating to the service to the Accounting Manager.

2. The method according to claim 1, further comprising, prior to the step of sending by the Service Provider an accounting message relating to the service to the Accounting Manager, the step of terminating the service.

3. The method according to claim 2, wherein the accounting message is a Final accounting message, and the method further comprises, prior to the step of terminating the service, the step of sending by the Service Provider at least one Interim accounting message relating to the service to the Accounting Manager.

4. The method according to claim 1, wherein the network further comprises an Accounting Storage, and the method further comprises, after the step of sending by the Service Provider an accounting message relating to the service to the Accounting Manager, the step of sending from the Accounting Manager to the Accounting Storage a Record Accounting message comprising accounting data.

5. The method according to claim 4, further comprising the steps of:
storing by the Accounting Storage the accounting data from the Record Accounting message;
sending by the Accounting Storage an Acknowledgement to the Accounting Manager; and
upon reception of the Acknowledgement, deleting by the Accounting Manager the accounting data it sent to the Accounting Storage in the Record Accounting message.

6. The method according to claim 1, further comprising, prior to the step of sending by the Accounting Manager a service credential to the User, the steps of:
selecting by the User a service;
sending by the User a service credential request related to the selected service to the Accounting Manager; and
validating by the Accounting Manager the service credential request.

7. The method according to claim 6, wherein the service credential request comprises:
an indication of a requested service;
a unique request identifier;
a random number; and
an electronic signature.

8. The method according to claim 7, wherein the service credential comprises:
the unique request identifier;
an address of the Service Provider;
an electronic key;
an accounting session identifier; and
an electronic signature.

9. The method according to claim 8, wherein the service credential further comprises:
a validity period for the service credential.

10. The method according to claim 8, wherein the service credential further comprises:
at least one condition for use of the credential.

11. The method according to claim 8, wherein the user credential comprises:
an address of the User;
the accounting session identifier;
an electronic key; and
an electronic signature.

12. The method according to claim 11, wherein the user credential further comprises policies regarding service access and accounting.

13. The method according to claim 11, wherein the step of requesting by the User a service from the Service Provider further comprises sending from the User a service request to the Service Provider, wherein the service request comprises:
the address of the user;
the accounting session identifier; and
an electronic signature.

14. The method according to claim 1, wherein the accounting message comprises:
an identifier of the service;
an indicator that the message comprises accounting data;
the user credential;
a unique accounting message identifier;
an accounting session identifier;
accounting data; and
an electronic signature.

15. A system for charging in a data communications network, the system comprising:
an Accounting Manager that:
sends a service credential to the User; and
sends a user credential to the Service Provider;
a User that requests a service from the Service Provider, using information from the service credential; and
a Service Provider that provides at least one service and that:
validates the service request, using information from the user credential; and
sends an accounting message relating to the service to the Accounting Manager.

16. The system according to claim 15, wherein the accounting message is a Final accounting message, and wherein the Service Provider further sends at least one Interim accounting message relating to the service to the Accounting Manager.

17. The system according to claim 15, wherein the system further comprises an Accounting Storage, and the Accounting Manager further sends a Record Accounting message comprising accounting data to the Accounting Storage.

18. The system according to claim 17, wherein:
the Accounting Storage:
stores the accounting data from the Record Accounting message; and
sends an Acknowledgement to the Accounting Manager; and
the Accounting Manager further deletes the accounting data it sent to the Accounting Storage in the Record Accounting message upon reception of the Acknowledgement.

19. The system according to claim 15, wherein the User further selects a service and sends a service credential request related to the selected service to the Accounting Manager, and the Accounting Manager further validates the service credential request prior to sending the service credential to the User.

20. The system according to claim 19, wherein the service credential request comprises:
an indication of a requested service;
a unique request identifier;
a random number; and
an electronic signature.

21. The system according to claim 20, wherein the service credential comprises:
the unique request identifier;
an address of the Service Provider;
an accounting session identifier;
an electronic key; and
an electronic signature.

22. The system according to claim 21, wherein the service credential further comprises:
a validity period for the service credential.

23. The system according to claim 21, wherein the service credential further comprises:
at least one condition for use of the credential.

24. The system according to claim 21, wherein the user credential comprises:
an address of the User;
an accounting identifier;
an electronic key;
the accounting session identifier; and
an electronic signature.

25. The system according to claim 24, wherein the user credential further comprises policies regarding service access and accounting.

26. The system according to claim 24, wherein the User requests a service from the Service Provider by sending to the Service Provider a service request comprising:
the address of the user;
the accounting session identifier; and
an electronic signature.

27. The system according to claim 15, wherein the accounting message comprises:
an identifier of the service;
an indicator that the message comprises accounting data;
the user credential;
a unique message identifier;
accounting data; and
an electronic signature.

28. The system according to claim 15, wherein the User further initiates the requested service.

29. The system according to claim 15, wherein the Account Manager further initiates the requested service.

30.A User node in a data communications network that further comprises a Service Provider and an Accounting Manager, the User node comprising:
a communication unit that:
receives a service credential from the Accounting Manager; and
requests a service from the Service Provider, using information from the service credential.

31. The User node according to claim 30, wherein the communication unit further sends a service credential request to the Accounting Manager.

32. The User node according to claim 30, wherein the User node further comprises a processing unit that activates the requested service.

33. An Accounting Manager in a data communications network that further comprises a User and a Service Provider, the Accounting Manager comprising:
a communication unit that:
sends a service credential to the User;
sends a user credential to the Service Provider; and
receives an accounting message from the Service Provider.

34. The Accounting Manager according to claim 33, wherein the accounting message is a Final accounting message and the communication unit further receives at least one Interim accounting message from the Service Provider.

35. The Accounting Manager according to claim 33, wherein the data communications network further comprises an Accounting Storage, and the communication unit further sends a Record Accounting message comprising accounting data to the Accounting Storage.

36. The Accounting Manager according to claim 35, wherein the communication unit further receives an Acknowledgement from the Accounting Storage, and the Accounting Manager further comprises a processing unit that, upon reception of the Acknowledgement, deletes the accounting data it sent to the Accounting Storage in the Record Accounting message.

37. The Accounting Manager of claim 33, wherein the communication unit further receives a service credential request from the User, and the Accounting Manager further comprises a processing unit that validates the service credential request prior to sending the service credential to the User

38. A Service Provider providing at least one service in a data communications network that further comprises a User and an Accounting Manager, wherein the Service Provider:
comprises a communication unit that:
receives a user credential from the Accounting Manager;
receives a request for a service from the User; and
sends an accounting message relating to the service to the Accounting Manager.

39. The Service Provider according to claim 38, wherein accounting message is a Final accounting message and the communication unit further sends at least one Interim accounting message relating to the service to the Accounting Manager.

40. The Service Provider according to claim 38 further comprising a processing unit that activates the requested service.

41. The Service Provider according to claim 40, wherein the processing unit further validates the request for a service.

42. A system for charging in a data communications network further comprising a User, the system comprising:
an Accounting Manager that:
sends a service credential to the User;
sends a user credential to the Service Provider; and
receives a request for a service from the User; and
a Service Provider that provides at least one service and that:
validates the service request, using information from the user credential; and
sends an accounting message relating to the service to the Accounting Manager.

43. The system according to claim 42, wherein the accounting message is a Final accounting message, and wherein the Service Provider further sends at least one Interim accounting message relating to the service to the Accounting Manager.

44. The system according to claim 42, wherein the system further comprises an Accounting Storage, and the Accounting Manager further sends a Record Accounting message comprising accounting data to the Accounting Storage.

45. The system according to claim 44, wherein:
the Accounting Storage:
stores the accounting data from the Record Accounting message; and
sends an Acknowledgement to the Accounting Manager; and
the Accounting Manager further deletes the accounting data it sent to the Accounting Storage in the Record Accounting message upon reception of the Acknowledgement.

46. The system according to claim 42, wherein the Accounting Manager further:
receives from the User a service credential request related to service selected by the User; and
validates the service credential request prior sending the service credential to the User.

47. The system according to claim 46, wherein the service credential request comprises:
an indication of a requested service;
a unique request identifier;
a random number; and
an electronic signature.

48. The system according to claim 47, wherein the service credential comprises:
the unique request identifier;
an address of the Service Provider;
an accounting session identifier;
an electronic key; and
an electronic signature.

49. The system according to claim 48, wherein the service credential further comprises:
a validity period for the service credential.

50. The system according to claim 48, wherein the service credential further comprises:
at least one condition for use of the credential.

51. The system according to claim 48, wherein the user credential comprises:
an address of the User;
an accounting identifier;
an electronic key;
the accounting session identifier; and
an electronic signature.

52. The system according to claim 51, wherein the user credential further comprises policies regarding service access and accounting.

53. The system according to claim 51, wherein the request for a service is a service request comprising:
the address of the user;
the accounting session identifier; and
an electronic signature.

54. The system according to claim 42, wherein the accounting message comprises:
an identifier of the service;
an indicator that the message comprises accounting data;
the user credential;
a unique message identifier;
accounting data; and
an electronic signature.

55. The system according to claim 42, wherein the Account Manager further initiates the requested service.
